(19) United States
(12) Patent Application Publication
(10) Pub. No.: US 2002/0083180 A1
(43) Pub. Date: Jun. 27, 2002

(54) Method for actuating network linking to internet from distant end

(76) Inventor: Yung-Cheng Lu, Taipei (TW)

Correspondence Address: Dike, Bronstein, Roberts & Cushman, Intellectual Property Practice Group, EDWARDS & ANGELL, P.O. Box 9169, Boston, MA, 02209, US

(21) Appl. No.: 09/799,473

(22) Filed: Mar. 5, 2001

(30) Foreign Application Priority Data
Dec. 26, 2000 (TW) 89127897

(51) Int. Cl. G06F 15/16

(52) U.S. Cl. 709/229; 709/217

(57) ABSTRACT

A method for actuating network linking operation of a designated device, e.g. a personal computer or an information appliance, from a distant end is disclosed. By establishing a correlation table between a client device and a designated signal channel at the ISP in advance, the ISP may send out a log-in signal in response to a request signal from a distant device to have the client device link to the internet.

### FIELD OF THE INVENTION

The present invention relates to a method for actuating network linkage of a designated device, and more particular to a method for actuating network linking operation of a designated device, e.g. a personal computer or an information appliance, from a distant end.

### BACKGROUND OF THE INVENTION

Please refer to FIG. 1 which is a schematic block diagram showing two general approaches for an internet service provider (ISP) to verify a user, and allow the verified user to link to the internet. A first personal computer 101 may connect to the ISP 12 to be verified via a modem 10 and telephone line 11 to log in to the internet 13. Alternatively, a second personal computer 141 may connect to the ISP 12 to be verified via a network interface card 14, LAN or intranet 15, and designated line 16 to log in to the internet 13.

For the first approach, the user has to turn on the PC 101 to connect to the ISP 12 first, and then execute the linking to the internet 13. In other words, if the user is not adjacent to the designated PC 101, the acquisition of information may be delayed.

For the second approach, the linking of the PC 141 to the internet 13 can be executed by connecting the PC 141 to the LAN or intranet 15 which is always connecting to the ISP 12 via the designated line 16. By keeping on this connection, information can be transmitted to the PC 141 at earliest time. The bandwidth of the designated line 16, however, will be inefficiently occupied by those computers which are linked but not in operation.

### SUMMARY OF THE INVENTION

Therefore, an object of the present invention is to provide a method for actuating network linking to the internet, which allows the linking to be performed from a distant end so that information can be acquired at any time without occupying the bandwidth of the designated line too long.

According to a first aspect of the present invention, a method for actuating a network linking operation of a first device to the internet via a designated signal channel by an internet service provider (ISP), includes steps of establishing a correlation table between the first device and the designated signal channel at the ISP; and sending out a log-in signal from the ISP in response to a request signal from a second device to have the first device link to the internet via the designated signal channel.

Preferably, the method further includes a step of entering a password to verify the request signal. More preferably, the method further includes a step of entering a password to verify the log-in signal.

In accordance with the present invention, the second device can be distant from the first device.

In accordance with another aspect of the present invention, the designated signal channel can be a telephone line, designated line, cable modem, asymmetric digital subscriber line (ADSL), integrated services digital network (ISDN) or DirectPC which is a kind of satellite network. Alternatively, the designated signal channel consists of a designated line, intranet and network interface card.

In accordance with another aspect of the present invention, the first device and the second device can be independently personal computers or information appliances.

According to a second aspect of the present invention, a method for actuating a client to the internet via a designated signal channel and an internet service provider (ISP), includes steps of establishing a correlation table between the client and the designated signal channel at the ISP; realizing the designated signal channel according to the correlation table in response to a request signal for linking the client; sending out a log-in signal to the client via the designated signal channel; and having the client link to the internet via the designated signal channel.

Preferably, the method further includes a step of entering a password to verify the request signal. More preferably, the method A further includes a step of entering a password to verify the log-in signal.

In accordance with the present invention, the request signal can be issued from a distant end, and the log-in signal is preferably issued from the ISP.

### BRIEF DESCRIPTION OF THE DRAWINGS

The present invention may best be understood through the following description with reference to the accompanying drawings, in which:

FIG. 1A is a schematic block diagram showing two general approaches to link to the internet via an internet service provider (ISP); and

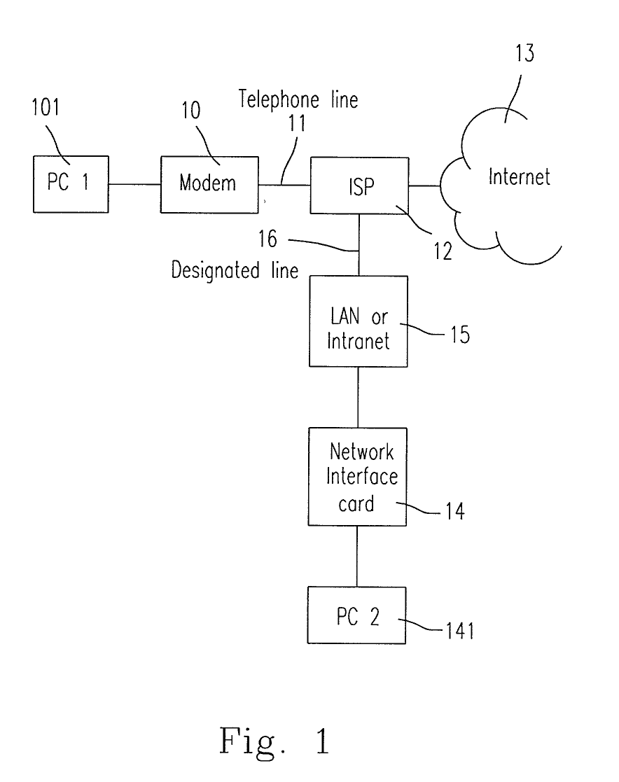

FIG. 2 is a schematic block diagram showing the actuation of a network linking operation from a distant end via an internet service provider (ISP) according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

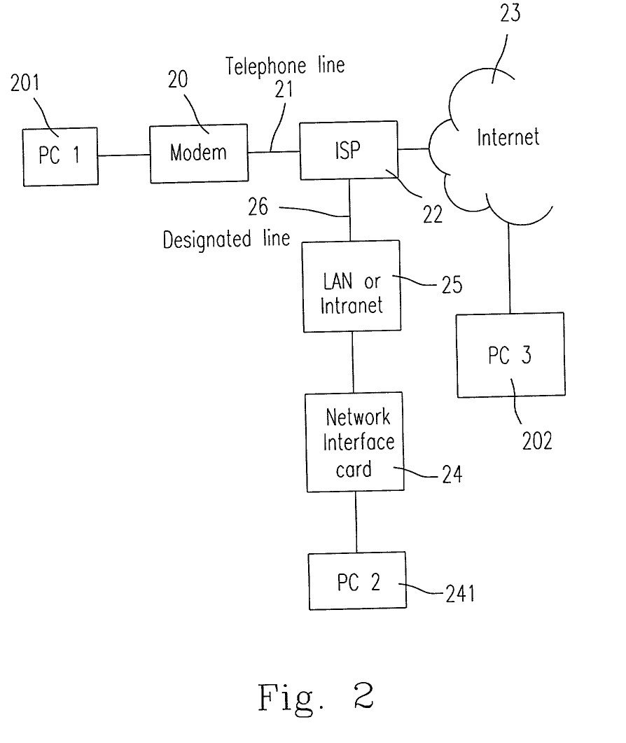

Please refer to FIG. 2. A first personal computer 201 may be connected to the ISP 22 to be verified via a modem 20 and telephone line 21 to log in to the internet 23. Alternatively, a second personal computer 241 may connect to the ISP 22 to be verified via a network interface card 24, LAN or intranet 25, and designated line 26 to log in to the internet 23. In order to allow the network linking of the PC 201 or 241 to the internet 23 to be actuated from a distant end, e.g. from a third personal computer 202, a correlation table between the PC 201 or 241 and the designated signal channel 21 or 26 and 24 is previously established at the ISP 22 by exchanging data upon connection. Accordingly, the PC 201 or 241 has its own unique index of position at the ISP 22. When a user gives a request command from the PC 202, the PC 201 or 241 can be reversely actuated by the ISP 22 according to the index of position.

For example, when a PC with a user name of “Deep & Far” is connected to the ISP via a modem and a telephone line with a telephone number of “02-23222023 ”, a correlation between the user name of Deep & Far and the telephone number of 02-23222023 is established and stored at the ISP by exchanging data. Afterwards, when the PC with the user name “Deep & Far” is in an off-line or software-off status, and a user would like to awake the PC from a distant end, the user may have another PC at the distant end on line, and give a request command such as “linking Deep & Far” to have the ISP check the correlation table and find the corresponding telephone number of 02-23222023. Accordingly, the ISP may dial the telephone number “02-23222023 ” to be connected to the modem of the PC with the user name of “Deep & Far” so as to actuate the off-line or software-off PC to link to the internet. By such reverse actuation, the acquisition of information will not be delayed even if the user is not adjacent to the designated PC. For example, a user can actuate his domestic PC from his office at any time as long as the correlation between the user name of the domestic PC and its corresponding signal channel is previously established at the ISP. Then the user can manipulate the domestic PC from the distant office. In addition to a personal computer, the client device to be actuated from a distant end can also be an information appliance (IA) in order to perform certain functions.

For security, it is preferred that the ISP asks for a password to identify the user who issues the request command to avoid illegal invasion. After the user is identified to be legal, it is more preferred that another password is requested by the off-line or software-off PC or IA to permit the reverse actuation operation by the ISP. For example, when the ISP sends a log-in command to the PC or IA to be actuated, the PC or IA enters an identification program such as that provided in BIOS, so that the ISP cannot arbitrarily actuate the PC or IA until the legal user enters the password.

For another example, when a PC with a user name of “Primax” is connected to the ISP via a network interface card with a card number of “123456 ”, intranet and designated line, a correlation among the user name of Primax, the network interface card number 123456 and the designated line is established and stored at the ISP by exchanging data. Afterwards, when the PC with the user name “Primax” is in a software-off, off-line to intranet or off-line to internet status, and a user would like to awake the PC from a distant end, the user may have another PC at the distant end on line, and give a request command such as “linking Priamx” to have the ISP check the correlation table and find the corresponding signal channel, i.e. the designated line and network interface card number 123456. Accordingly, the ISP may be connected to the PC with the user name of “Primax” via the designated signal channel so as to actuate the PC to link to the internet. By such reverse actuation, it is not necessary to keep on connecting PCs in the intranet to the ISP, and the information can still be acquired whenever it is required. Therefore, the bandwidth of the designated line can be efficiently used.

In the above examples, the designated signal channel is a telephone line or a designated line plus network interface card. Alternatively, the signal channel can also be cable modem, asymmetric digital subscriber line (ADSL), integrated services digital network (ISDN) or DirectPC. The correlation between the client device to be actuated and the signal channel is established at the ISP in a similar way as described above.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for actuating a network linking operation of a first device to the internet via a designated signal channel by an internet service provider (ISP), comprising steps of:
establishing a correlation table between said first device and said designated signal channel at said ISP; and
sending out a log-in signal from said ISP in response to a request signal from a second device to have said first device link to the internet via said designated signal channel.

2. The method according to claim 1 further comprising a step of entering a password to verify said request signal.

3. The method according to claim 1 further comprising a step of entering a password to verify said log-in signal.

4. The method according to claim 1 wherein said first device is separate from said second device.

5. The method according to claim 1 wherein said designated signal channel is a telephone line.

6. The method according to claim 1 wherein said designated signal channel is a designated line.

7. The method according to claim 1 wherein said designated signal channel is a cable modem.

8. The method according to claim 1 wherein said designated signal channel is an asymmetric digital subscriber line (ADSL).

9. The method according to claim 1 wherein said designated signal channel is an integrated services digital network (ISDN).

10. The method according to claim 1 wherein said designated signal channel is a DirectPC network.

11. The method according to claim 1 wherein said designated signal channel consists of a designated line, intranet and network interface card.

12. The method according to claim 1 wherein said first device is a personal computer.

13. The method according to claim 1 wherein said first is an information appliance.

14. The method according to claim 1 wherein said second device is a personal computer.

15. The method according to claim 1 wherein said second device is an information appliance.

16. A method for actuating a network linking operation of a client to the internet via a designated signal channel and an internet service provider (ISP), comprising steps of:
establishing a correlation table between said client and said designated signal channel at said ISP;
realizing said designated signal channel according to said correlation table in response to a request signal for linking said client;
sending out a log-in signal to said client via said designated signal channel; and
having said client link to the internet via said designated signal channel.

17. The method according to claim 16 further comprising a step of entering a password to verify said request signal.

18. The method according to claim 16 further comprising a step of entering a password to verify said log-in signal.

19. The method according to claim 16 wherein said request signal is issued from a distant end.

20. The method according to claim 16 wherein said log-in signal is issued from said ISP.
